(19) United States
(12) Patent Application Publication
(10) Pub. No.: US 2014/0279302 A1
(43) Pub. Date: Sep. 18, 2014

(54) AUTOMATIC BUDGET TRACKING AND NOTIFICATION

(71) Applicant: Jeremiah Joseph Akin, Pleasat Hill, CA (US)

(72) Inventor: Jeremiah Joseph Akin, Pleasat Hill, CA (US)

(73) Assignee: eBay Inc., San Jose, CA (US)

(21) Appl. No.: 13/838,758

(22) Filed: Mar. 15, 2013

(51) Int. Cl. G06Q 40/00

(52) U.S. Cl. CPC G06Q 40/10
USPC 705/30

(57) ABSTRACT

A system and method of automatic budget tracking and notification are described. Location information corresponding to a user may be received. A current budget category for the user may be determined based on the location information. A budget quantity corresponding to the current budget category may be stored on a database. A remaining quantity corresponding to the current budget category may be caused to be displayed to the user on a mobile device. The remaining quantity may represent an amount of the budget quantity that is available to be expended. The remaining quantity and the budget quantity corresponding to the current budget category may be monetary quantities. The location information may be received via a social networking check-in application.

### TECHNICAL FIELD

The present application relates generally to the technical field of data processing, and, in various embodiments, to systems and methods of automatic budget tracking and notification.

### BACKGROUND

People often set up a budget for themselves indicating how they plan to spend their money over a period of time. However, when arriving at a location (e.g., a store) where a portion of their budget may be expended, people do not automatically know how much of their budget is still available to be expended.

### BRIEF DESCRIPTION OF THE DRAWINGS

Some embodiments of the present disclosure are illustrated by way of example and not limitation in the figures of the accompanying drawings, in which like reference numbers indicate similar elements, and in which:

FIG. 1 is a block diagram depicting a network architecture of a system having a client-server architecture configured for exchanging data over a network, in accordance with an example embodiment;

FIG. 2 is a block diagram illustrating a budget tracking and notification system, in accordance with an example embodiment;

FIG. 3 illustrates a user account, in accordance with an example embodiment;

FIG. 4 illustrates a remaining quantity corresponding to a budget category being displayed on a mobile device, in accordance with an example embodiment;

FIG. 5 is a flowchart illustrating a method of budget tracking and notification, in accordance with an example embodiment; and

FIG. 6 shows a diagrammatic representation of a machine in the example form of a computer system within which a set of instructions may be executed to cause the machine to perform any one or more of the methodologies discussed herein, in accordance with an example embodiment.

### DETAILED DESCRIPTION

The description that follows includes illustrative systems, methods, techniques, instruction sequences, and computing machine program products that embody illustrative embodiments. In the following description, for purposes of explanation, numerous specific details are set forth in order to provide an understanding of various embodiments of the inventive subject matter. It will be evident, however, to those skilled in the art that embodiments of the inventive subject matter may be practiced without these specific details. In general, well-known instruction instances, protocols, structures, and techniques have not been shown in detail.

The present disclosure describes systems and methods of automatic budget tracking and notification. A user may be notified of the current amount remaining to be spent in a budget category when the user is at the location where he or she would spend the money (or other budget quantity, e.g., food points or calories) in that category.

In some embodiments, a system may comprise at least one processor, a database, and a budget tracking and notification module. The database may be configured to store a budget quantity corresponding to a budget category for a user. The budget tracking and notification module may be executable by the at least one processor and configured to receive location information corresponding to the user, determine that the budget category is a current budget category for the user based on the location information, and cause a remaining quantity corresponding to the current budget category to be displayed to the user on a mobile device. The remaining quantity may represent an amount of the budget quantity that is available to be expended.

In some embodiments, the budget category may be one of a plurality of budget categories stored on the database. Each budget category in the plurality of budget categories may have a corresponding budget quantity. In some embodiments, determining the current budget category may comprise determining the current budget category amongst the plurality of budget categories. In some embodiments, the remaining quantity and the budget quantity corresponding to the current budget category may be monetary quantities. In some embodiments, the budget quantity may represent an amount that is available to be expended for a specified period of time. In some embodiments, the database may be further configured to store the remaining quantity corresponding to the budget category, and the budget tracking and notification module may be configured to set the remaining quantity corresponding to the budget category to equal the budget quantity corresponding to the budget category in response to the specified period of time elapsing. In some embodiments, the budget tracking and notification module may be configured to receive the location information via a social networking check-in application. In some embodiments, the database may be further configured to store the remaining quantity corresponding to the budget category, and the budget tracking and notification module may be further configured to receive expenditure information regarding a portion of the budget quantity corresponding to the budget category being expended, and to adjust the remaining quantity corresponding to the budget category based on the expenditure information.

In some embodiments, a computer-implemented method may comprise receiving location information corresponding to a user, and determining, by a machine, a current budget category for the user based on the location information. A budget quantity corresponding to the current budget category may be stored on a database. A remaining quantity corresponding to the current budget category may be caused to be displayed to the user on a mobile device. The remaining quantity may represent an amount of the budget quantity that is available to be expended.

In some embodiments, the current budget category may be one of a plurality of budget categories stored on the database. Each budget category in the plurality of budget categories may have a corresponding budget quantity. In some embodiments, determining the current budget category may comprise determining the current budget category amongst the plurality of budget categories. In some embodiments, the remaining quantity and the budget quantity corresponding to the current budget category may be monetary quantities. In some embodiments, the budget quantity corresponding to the current budget category may represent an amount that is available to be expended for a specified period of time. In some embodiments, the remaining quantity corresponding to the budget category may be stored on the database, and the remaining quantity corresponding to the budget category may be set to equal the budget quantity corresponding to the budget category in response to the specified period of time elapsing. In some embodiments, the location information may be received via a social networking check-in application. In some embodiments, the method may further comprise storing the remaining quantity corresponding to the budget category, receiving expenditure information regarding a portion of the budget quantity corresponding to the budget category being expended, and adjusting the remaining quantity corresponding to the budget category based on the expenditure information.

In some embodiments, a non-transitory machine-readable storage device may store a set of instructions that, when executed by at least one processor, causes the at least one processor to perform the operations or method steps discussed within the present disclosure.

FIG. 1 is a network diagram depicting a client-server system 100, within which one example embodiment may be deployed. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more databases servers 124 that facilitate access to one or more databases 126. According to various exemplary embodiments, the applications 120 may correspond to one or more of the modules of the system 200 illustrated in FIG. 2. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

FIG. 2 is a block diagram illustrating a budget tracking and notification system 200, in accordance with an example embodiment. In some embodiments, the budget tracking and notification system 200 may comprise at least one processor (not shown), one or more databases 250, and a budget tracking and notification module 240. In some embodiments, the database(s) 250 may be incorporated into the database(s) 126 in FIG. 1. The database(s) 250 may be configured to store a plurality of budget categories for a user account 255 assigned or otherwise corresponding to a user 205. The database(s) may store a plurality of user accounts 255 for a plurality of corresponding users 205.

FIG. 3 illustrates details of a user account 255, in accordance with an example embodiment. As seen in FIG. 3, the user account 255 may have a plurality of budget categories 310. The budget categories 310 may be categories of expenditures for which the user 205 may assign and store a budget. For example, the user 205 may create a budget for restaurant expenditures, a budget for supermarket expenditures, a budget for clothing expenditures, and a budget for movie expenditure. It is contemplated that other number and types of budget categories 310 are within the scope of the present disclosure.

Each budget category 310 may have a corresponding budget quantity 320 and a corresponding remaining quantity 330. The budget quantity 320 may represent the total amount of the budget for the corresponding budget category 310. For example, as seen in FIG. 3, the user 205 may set the budget quantity 320 for restaurant expenditures at $175.00, the budget quantity 320 for supermarket expenditures at $200.00, the budget quantity 320 for clothing expenditures at $80.00, and the budget quantity 320 for movie expenditures at $40.00. The budget quantities 320 may represent a maximum amount that the user 205 does not want to exceed. In some embodiments, budget quantities 320 may represent a maximum amount that the user 205 does not want to exceed in a specified period of time. For example, the budget quantities 320 may represent a daily budget, a weekly budget, a monthly budget, a yearly budget, and so on and so forth. It is contemplated that the user may specify different periods of time for different budget categories 310.

The corresponding remaining quantity 330 for each budget category 310 may represent an amount of the corresponding budget quantity 320 that is available to be expended. For example, as seen in FIG. 3, the remaining quantity 330 out of the $175.00 budget quantity 320 for restaurant expenditures may be $35.43, meaning that the user still has $35.43 to spend on restaurant expenditures for the specified time period (e.g., for the month). Similarly, the remaining quantity 330 out of the $200.00 budget quantity 320 for supermarket expenditures may be $160.62, meaning that the user still has $160.62 to spend on supermarket expenditures for the specified time period, the remaining quantity 330 out of the $80.00 budget quantity 320 for clothing expenditures may be $80.00, meaning that the user has not yet had any clothing expenditures for the specified time period and still has $80.00 to spend on clothing expenditures for the specified time period, and the remaining quantity 330 out of the $40.00 budget quantity 320 for movie expenditures may be $0.00, meaning that the user has spent all of the previously available $40.00 budget quantity 320 for movie expenditures and now has nothing remaining to spend on movie expenditures for the specified time period.

In some embodiments, the budget tracking and notification module 240 may be configured to reset the remaining quantity after and in response to the specified time elapsing (e.g., at the end of the month) so that it equals the corresponding budget quantity. For example, referring back to FIG. 3, at the end of the month, the remaining quantity 330 for the restaurant budget category 310 may be reset to $175.00, the remaining quantity 330 for the supermarket budget category 310 may be reset to $200.00, the remaining quantity 330 for the clothing budget category 310 may be reset to $80.00, and the remaining quantity 330 for the movie budget category 310 may be reset to $40.00.

In some embodiments, the budgets are monetary budgets, so that the remaining quantity 330 and the budget quantity 320 are monetary quantities. However, it is contemplated that non-monetary budgets are within the scope of the present invention. For example, the user 205 may set up a budget for tracking food consumption for a specified period of time, such as a daily budget for calories.

Referring back to FIG. 2, the budget tracking and notification module 240 may be configured to determine the user's current location. The budget tracking and notification module 240 may then determine which, if any, of the user's budget categories 310 corresponds to the user's location. In some embodiments, the supply of this location information may originate from a mobile device 210 being used by the user 205. Examples of a mobile device 210 may include, but are not limited to, a cellular phone and a tablet computer. It is contemplated that other types of mobile devices 210 are also within the scope of the present disclosure. In some embodiments, the location information may be obtained using a social networking check-in application, such as a check-in application provided by Foursquare or Facebook. For example, the user 205 may check in to a location or venue using a mobile website, text messaging, or a device-specific application via the mobile device 210. The check-in application may use the GPS hardware in the mobile device or the network location provided by the application in order to obtain the user's location. In some embodiments, the check-in application may be incorporated into the budget tracking and notification system 200, such as in the budget tracking and notification module. In some embodiments, the check-in application may be a third-party check-in application 230, external to and independent from the budget tracking and notification system 200.

The budget tracking and notification module 240 may determine a current budget category that corresponds to the user's current location. For example, if the user 205 walks into a restaurant and checks in to the restaurant using the third-party check-in application 230, the budget tracking and notification module 240 may then determine that the current budget category for the user is the user's restaurant budget category. The budget tracking and notification module 240 may then determine the corresponding remaining quantity for the current budget category, and cause the remaining quantity to be displayed to the user on a mobile device.

FIG. 4 illustrates a remaining quantity 420 corresponding to a budget category being displayed on a mobile device 210, in accordance with an example embodiment. The remaining quantity 420 may be provided to the user 205 in the form of a message. For example, if the remaining quantity for the user's restaurant budget is determined to be $35.43, a message may be displayed to the user reading, “You have $35.43 left in your restaurant budget for this month.” It is contemplated that notification of the remaining quantity may be provided to the user 205 in a variety of ways, including, but not limited to, a notification being sent to an application installed on the user's mobile device 210 or a notification being sent via a text message. Other forms of notification are also within the scope of the present disclosure.

After the user 205 spends a portion of the remaining quantity for the corresponding budget category, the remaining quantity may be updated to reflect the portion that has been expended. The budget tracking and notification module 240 may be configured to receive expenditure information regarding the portion of a budget quantity that has been expended, and to adjust the remaining quantity corresponding to that budget category based on the expenditure information. For example, the budget tracking and notification module 240 may receive information regarding the user 205 spending $10.00 at a restaurant. Referring back to FIG. 3, the remaining quantity 330 for the user's restaurant budget category 310 may then be reduced from $35.43 to $25.43 to reflect the $10.00 expenditure. In some embodiments, the expenditure information may be provided by the user 205 directly entering the information into the budget tracking and notification system 200, such as when the user 205 is managing his or her user account 255 online or via a mobile application based on the budget tracking and notification system. In some embodiments, the user 205 may provide the expenditure information to a third-party financial management application 260 (e.g., Mint.com), which may then send the expenditure information to the budget tracking and notification system 200.

In some embodiments, in addition or as an alternative to storing corresponding remaining quantities 330 for budget categories 310, the expenditures 340 corresponding to each budget category 310 may be tracked and stored. In some embodiments, upon the user 205 checking-in at a location, the budget tracking and notification module 240 may perform an on-demand calculation with the corresponding expenditures 340 for the budget category 310 corresponding to the location at which the user 205 checked in so that the corresponding remaining quantity 330 can be determined without having to store the remaining quantities 330. For example, the budget tracking and notification module 240 may subtract the corresponding expenditures 340 from the corresponding budget quantity 320 to determine the corresponding remaining quantity 330 for the corresponding budget category 310.

In some embodiments, as with the reset of the remaining quantity previously discussed, the budget tracking and notification module 240 may be additionally or alternatively configured to reset the expenditures after and in response to the specified time elapsing (e.g., at the end of the month) so that it equals zero. For example, referring back to FIG. 3, at the end of the month, the expenditures 340 for the restaurant budget category 310, the supermarket budget category 310, the clothing budget category 310, and the movie budget category 310 may all be reset to $0.00.

In some embodiments, some or all of the modules and components of the budget tracking and notification system 200 may be incorporated into or implemented using the components of publication system 102 in FIG. 1. For example, the budget tracking and notification module 240 and the location determination module 230 may be incorporated into the application servers 118. In addition, the modules and components of FIG. 2 may have separate utility and application outside of the publication system 102 of FIG. 1.

It is contemplated that the sending and providing of information and notifications discussed herein may be achieved via a network 220. The network 220 may be any network that enables communication between or among machines, databases, and devices. Accordingly, the network 220 may be a wired network, a wireless network (e.g., a mobile or cellular network), or any suitable combination thereof. The network 410 may include one or more portions that constitute a private network, a public network (e.g., the Internet), or any suitable combination thereof.

FIG. 5 is a flowchart illustrating a method 500 of budget tracking and notification, in accordance with an example embodiment. It is contemplated that the operations of method 500 may be performed by a system or modules of a system (e.g., budget tracking and notification module 240 in FIG. 2).

At operation 510, the user 205 may be enabled to configure one or more budget categories 310. This configuration may include establishing or adjusting budget categories 310, budget quantities 320, remaining quantities 330, and/or expenditures.

At operation 520, location information for the user 205 may be determined. In some embodiments, this location information may be obtained via the user's mobile phone 210 and a check-in application. At operation 530, a current budget category 310 may be determined for the user 205 based on the location information for the user 205. At operation 540, the remaining quantity 330 available to be expended for the current budget category 310 may be determined. As previously discussed, the remaining quantity 330 may be determined in a variety of different ways. In some embodiments, the remaining quantity 330 may be determined by retrieving it from a database 250. In some embodiments, the remaining quantity 330 may be determined by subtracting expenditures 340 for the current budget category 310 from the budget quantity 320 for the current budget category 310. At operation 550, the remaining quantity 330 may be caused to be displayed to the user 205 on the mobile device 210.

At operation 560, it is determined whether a new expenditure has been made for a budget category 310 of the user 205. If no new expenditure has been made, then the method may proceed to operation 580. If a new expenditure has been made, then, at operation 570, the remaining quantity 330 for the corresponding budget category 310 and/or the expenditures 340 for the corresponding budget category 310 may be adjusted based on the expenditure information.

At operation 580, it is determined whether a specified time period for any of the user's budget categories 310 has elapsed (e.g., end of the month). If a specified time period has elapsed for a budget category 310, then, at operation 590, the corresponding remaining quantity 330 for that budget category 310 may be reset (e.g., set to equal the budget quantity 320) and/or the corresponding expenditures 340 for that budget category 310 may be reset (e.g., set to equal zero). The method 500 may return to enabling the user 205 to configure budget categories at operation 510 or determining location information for the user 205 at operation 520 if no specified time period has elapsed at operation 580 or after the remaining quantity 330 and/or the expenditures 340 have been reset at operation 590. It is contemplated that any of the other features described within the present disclosure may be incorporated into method 500.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 104 of FIG. 1) and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

FIG. 6 is a block diagram of a machine in the example form of a computer system 600 within which instructions for causing the machine to perform any one or more of the methodologies discussed herein may be executed, in accordance with an example embodiment. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a user interface (UI) navigation (or cursor control) device 614 (e.g., a mouse), a disk drive unit 616, a signal generation device 618 (e.g., a speaker), and a network interface device 620.

### Machine-Readable Medium

The disk drive unit 616 includes a machine-readable medium 622 on which is stored one or more sets of data structures and instructions 624 (e.g., software) embodying or utilized by any one or more of the methodologies or functions described herein. The instructions 624 may also reside, completely or at least partially, within the main memory 604 and/or within the processor 602 during execution thereof by the computer system 600, the main memory 604 and the processor 602 also constituting machine-readable media. The instructions 624 may also reside, completely or at least partially, within the static memory 606.

While the machine-readable medium 622 is shown in an example embodiment to be a single medium, the term “machine-readable medium” may include a single medium or multiple media (e.g., a centralized or distributed database, and/or associated caches and servers) that store the one or more instructions 624 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 624 may further be transmitted or received over a communications network 626 using a transmission medium. The instructions 624 may be transmitted using the network interface device 620 and any one of a number of well-known transfer protocols (e.g., HTTP). Examples of communication networks include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A system comprising:
at least one processor;
a database configured to store a budget quantity corresponding to a budget category for a user;
a budget tracking and notification module, executable by the at least one processor, configured to:
receive location information corresponding to the user;
determine that the budget category is a current budget category for the user based on the location information;
determine a remaining quantity corresponding to the current budget category, the remaining quantity representing an amount of the budget quantity that is available to be expended; and
cause the remaining quantity corresponding to the current budget category to be displayed to the user on a mobile device.

2. The system of claim 1, wherein:
the budget category is one of a plurality of budget categories stored on the database, each budget category in the plurality of budget categories having a corresponding budget quantity; and
determining the current budget category comprises determining the current budget category amongst the plurality of budget categories.

3. The system of claim 1, wherein the remaining quantity and the budget quantity corresponding to the current budget category are monetary quantities.

4. The system of claim 1, wherein the budget quantity represents an amount that is available to be expended for a specified period of time.

5. The system of claim 4, wherein the database is further configured to store the remaining quantity corresponding to the budget category, and the budget tracking and notification module is configured to set the remaining quantity corresponding to the budget category to equal the budget quantity corresponding to the budget category in response to the specified period of time elapsing.

6. The system of claim 1, wherein the budget tracking and notification module is configured to receive the location information via a social networking check-in application.

7. The method of claim 1, wherein the database is further configured to store the remaining quantity corresponding to the budget category, and the budget tracking and notification module is further configured to:
receive expenditure information regarding a portion of the budget quantity corresponding to the budget category being expended; and
adjust the remaining quantity corresponding to the budget category based on the expenditure information.

8. A computer-implemented method comprising:
receiving location information corresponding to a user;
determining, by a machine, a current budget category for the user based on the location information, wherein a budget quantity corresponding to the current budget category is stored on a database; and
causing a remaining quantity corresponding to the current budget category to be displayed to the user on a mobile device, the remaining quantity representing an amount of the budget quantity that is available to be expended.

9. The method of claim 8, wherein:
the current budget category is one of a plurality of budget categories stored on the database, each budget category in the plurality of budget categories having a corresponding budget quantity; and
determining the current budget category comprises determining the current budget category amongst the plurality of budget categories.

10. The method of claim 8, wherein the remaining quantity and the budget quantity corresponding to the current budget category are monetary quantities.

11. The method of claim 8, wherein the budget quantity corresponding to the current budget category represents an amount that is available to be expended for a specified period of time.

12. The method of claim 11, wherein the remaining quantity corresponding to the budget category is stored on the database, and wherein the remaining quantity corresponding to the budget category is set to equal the budget quantity corresponding to the budget category in response to the specified period of time elapsing.

13. The method of claim 8, wherein the location information is received via a social networking check-in application.

14. The method of claim 8, further comprising:
storing the remaining quantity corresponding to the budget category;
receiving expenditure information regarding a portion of the budget quantity corresponding to the budget category being expended; and
adjusting the remaining quantity corresponding to the budget category based on the expenditure information.

15. A non-transitory machine-readable storage device storing a set of instructions that, when executed by at least one processor, causes the at least one processor to perform a set of operations comprising:
receiving location information corresponding to a user;
determining a current budget category for the user based on the location information, wherein a budget quantity corresponding to the current budget category is stored on a database; and
causing a remaining quantity corresponding to the current budget category to be displayed to the user on a mobile device, the remaining quantity representing an amount of the budget quantity that is available to be expended.

16. The machine-readable storage device of claim 15, wherein:
the current budget category is one of a plurality of budget categories stored on the database, each budget category in the plurality of budget categories having a corresponding budget quantity; and
determining the current budget category comprises determining the current budget category amongst the plurality of budget categories.

17. The machine-readable storage device of claim 15, wherein the remaining quantity and the budget quantity corresponding to the current budget category are monetary quantities.

18. The machine-readable storage device of claim 15, wherein the budget quantity represents an amount that is available to be expended for a specified period of time.

19. The machine-readable storage device of claim 18, wherein the set of operations further comprises storing the remaining quantity corresponding to the budget category on the database, and setting the remaining quantity corresponding to the budget category to equal the budget quantity corresponding to the budget category in response to the specified period of time elapsing.

20. The machine-readable storage device of claim 15, wherein the set of operations further comprises receiving the location information via a social networking check-in application.
